(19) United States
(12) Patent Application Publication
(10) Pub. No.: US 2007/0217330 A1
(43) Pub. Date: Sep. 20, 2007

(54) Ring network system, node device, and protection band testing method for the ring network system

(75) Inventor: Naokatsu Ohkawa, Kanazawa (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/495,606

(22) Filed: Jul. 31, 2006

(30) Foreign Application Priority Data
Mar. 17, 2006 (JP) 2006-075479

(51) Int. Cl. H04J 1/16

(52) U.S. Cl. 370/222

(57) ABSTRACT

In a ring network system, a first node device includes means for sending out a control signal for controlling one of a plurality of second node devices so as to allow signals transmitted over a protection band to pass through the second node device; each of the second node devices includes means for receiving the control signal sent out from the first node device or another second node device, means for controlling the signals transmitted over the protection band to pass through the second node device during the reception of the control signal, and means for transferring the control signal to the adjacent first node device or to the adjacent second node device during the reception of the control signal; and the first node device further includes means for receiving the control signal transferred from the adjacent second node device.

### BACKGROUND OF THE INVENTION

1. Field of the Invention

The present invention relates to a ring network system in which a plurality of node devices are connected in a ring configuration and in which a working band and a protection band combine to form a redundant transmission band pair, to a node device, and to a protection band testing method for the ring network system.

2. Description of the Related Art

A synchronous optical network (SONET) ring is a ring network in which a plurality of SONET/synchronous digital hierarchy transmission (SDH) devices (or SONET devices) with add-drop multiplexer (ADM) capabilities act as node devices. The SONET ring is used in networks, ranging in size from small citywide networks to large nationwide networks. Typical redundancy schemes for the SONET ring include a bi-directional line switched ring (BLSR), which comes in two varieties: a two-fiber BLSR (2F-BLSR) and a four-fiber BLSR (4F-BLSR). In the 2F-BLSR, a transmission band of a single optical fiber for each of different directions (EAST direction and WEST direction) is divided into a current band (working band) and a backup band (protection band). The current band is used for transmitting signals under normal line conditions, while the backup band is used for diverting the signals in the case of a line failure. In the 4F-BLSR, both current and backup optical fibers are provided for each of EAST and WEST directions. Hereinafter, a 2F-BLSR SONET ring will be described in detail.

FIG. 8 is a diagram for illustrating the 2F-BLSR. Node devices 61, 62, 63, 64, and 65 are SONET devices with ADM capabilities. An EAST line 101 is an optical fiber for EAST direction, and a WEST line 201 is an optical fiber for WEST direction. A working band 102 and a protection band 103 are provided for the EAST line 101, and a working band 202 and a protection band 203 are provided for the WEST line 201. An ADD line 301 is added to the working band 102 of the EAST line 101 at the node device 61. A DROP line 302 is dropped from the working band 102 of the EAST line 101 at the node device 63. An ADD line 401 is added to the working band 202 of the WEST line 201 at the node device 63. A DROP line 402 is dropped from the working band 202 of the WEST line 201 at the node device 61.

The node devices 61 to 65 are connected in a ring configuration via the EAST line 101 and the WEST line 201. The transmission band of the EAST line 101 is divided into two sub-bands, i.e., the working band 102 for current use and the protection band 103 for backup. Likewise, the transmission band of the WEST line 201 is divided into two sub-bands, i.e., the working band 202 for current use and the protection band 203 for backup. In general, the widths of a working band and a protection band are the same. For example, when an optical carrier 48 (OC48) line with a capacity of 2.4 Gbps is used, 48 channels of a synchronous transport signal-1 (STS-1) for each of the EAST line 101 and the WEST line 201 are assigned equally to the working band and protection band, i.e., channels 1 to 24 are assigned to the working band and channels 25 to 48 are assigned to the protection band.

The following describes an example in which concatenated synchronous transport signal-3c (STS-3c) signals are transmitted between the node device 61 and the node device 63 over channels 1 to 3. The node device 61 adds signals on the ADD line 301 to channels 1 to 3 of the EAST line 101. The node device 62 allows the signals on channels 1 to 3 of the EAST line 101 to pass through (THRU). The node device 63 drops the signals on channels 1 to 3 of the EAST line 101 to the DROP line 302. Likewise, the node device 63 adds signals on the ADD line 401 to channels 1 to 3 of the WEST line 201. The node device 62 allows the signals on channels 1 to 3 of the WEST line 201 to pass through. The node device 61 drops the signals on channels 1 to 3 of the WEST line 201 to the DROP line 402. For the node devices 61, 62, and 63, a network management system (NMS, not shown) manages ADD control, DROP control, THRU control, and the selection of appropriate channels by using ADM control signals for controlling ADM switching functions and channels to be switched.

FIG. 9 is a diagram (1) illustrating the redundancy capabilities of a 2F-BLSR network, which has the same system configuration as that of the 2F-BLSR network illustrated in FIG. 8. The following describes switching operation performed for the protection of line signals when transmission over the EAST line 101 between the node device 61 and the node device 62 is interrupted due to a fiber failure or the like.

First, the node device 61 adds signals on the ADD line 301 to channels 25 to 27 corresponding to the protection band 203 of the WEST line 201. The node devices 65, 64, and 63 allows the signals on channels 25 to 27 of the WEST line 201 to pass through. The node device 62 directs the signals on channels 25 to 27 to channels 1 to 3 corresponding to the working band 102 of the EAST line 101. The node device 63 drops the signals on channels 1 to 3 of the EAST line 101 to the DROP line 302. Then, the node device 62 directs signals on channels 1 to 3 of the WEST line 201 to channels 25 to 27 corresponding to the protection band 103 of the EAST line 101. The node devices 63, 64, and 65 allows the signals on channels 25 to 27 of the EAST line 101 to pass through. The node device 61 drops the signals on channels 25 to 27 of the EAST line 101 to the DROP line 402. Thus, the signals transmitted over the failed line can be protected by the above-described switching operation in the ring network system.

In the switching operation of the ring network system described above, auto protection switching (APS) bytes constituting K1 and K2 bytes of the section overhead of a SONET/SDH frame are used. To protect signals on the failed line, a loopback circuit is created by the exchange of messages between nodes (e.g., the node devices 61 and 62 in FIG. 9) at both sides of the point of failure. In addition, the other nodes (e.g., the node devices 63, 64, and 65 in FIG. 9) need to allow the APS bytes containing the destination address to pass through. Japanese Unexamined Patent Application Publication No. 7-95225 discusses a method in which the address of a working node device is compared with addresses contained in APS bytes so as to increase the speed of pass-through processing for allowing the APS bytes to pass through.

FIG. 10 is a diagram (2) illustrating the redundancy capabilities of a 2F-BLSR network. FIG. 10 illustrates the same switching operation as that illustrated in FIG. 9.

Generally, in a system with redundancy capabilities, line conditions of a protection band are not monitored. Therefore, when a channel failure in the protection band occurs, for example, on the WEST line 201 and between the node device 64 and the node device 63 and affects channels 25 to 27, it can only be found after the completion of the switching operation illustrated in FIG. 9 that the signals on channels 1 to 3 cannot be protected by the switching operation.

FIG. 11 illustrates a line test performed on a 2F-BLSR network, which has the same system configuration as that of the 2F-BLSR network illustrated in FIG. 8, except that each of the node devices 61 to 65 in FIG. 11 includes a test controller 70. The following describes a line test performed on the working band 102 from the node device 61 to the node device 63, and on the working band 202 from the node device 63 to the node device 61.

The node devices 61 to 65 are connected to the network management system (NMS, not shown). For a line test, the NMS sends control signals 601 to 605 to the node devices 61 to 65, respectively, and the node devices 61 to 65 send the corresponding response signals 601 to 605 back to the NMS. To perform a test for evaluating the communication quality of a path, for example, from the node device 61 to the node device 63 under the control of the NMS, a test signal generation unit of the test controller 70 for the node device 61 sends out a test signal to the working band 102 of the EAST line 101. Then, a test signal measurement unit of the test controller 70 for the node device 63 performs a measurement on the transmitted test signal to evaluate the communication quality. Likewise, a test signal generation unit of the test controller 70 for the node device 63 sends out a test signal to the working band 202 of the WEST line 201. Then, a test signal measurement unit of the test controller 70 for the node device 61 performs a measurement on the transmitted test signal to evaluate the communication quality. The minimum unit of measurement for the evaluation of communication quality is STS-1, which is the channel unit. For the evaluation of communication quality, the number of occurrences of error signals and the cumulative number of occurrences of error signals per day or per 15 minutes are counted.

In general, measurement for the evaluation of communication quality, such as that described above, is performed only on the working band of the ring network system and not on the protection band.

As described above, in the SONET BLSR network, it is possible to check the communication quality of channels in the working band. However, channels in the protection band are defined as “unused” and there is no means for creating a path for checking the communication quality of the channels. Therefore, the communication quality of channels in the protection band cannot be evaluated. The communication quality of such channels can only be evaluated when the channels are defined as being in the working band after the completion of switching operation performed due to a line failure.

### SUMMARY OF THE INVENTION

Accordingly, an object of the present invention is to provide a ring network system that includes a means for setting a path for checking the communication quality of a protection band and is capable of creating, in the protection band, a ring path starting at a first node device, passing through a second node device, and ending at the first node device.

According to an aspect of the present invention, a ring network system includes a first node device, a plurality of second node devices, and a transmission line for connecting the first node device and the plurality of second node devices in a ring configuration. In the ring network system, each of the first device and the second devices combines a working band used as a normal band for transmitting signals and a protection band used as an alternative band for diverting signals to form a redundant transmission band pair. The first node device includes means for sending out a protection band control signal for controlling one of the second node devices so as to allow signals transmitted over the protection band to pass through the second node device. Each of the second node devices includes means for receiving the protection band control signal sent out from the first node device or another second node device, means for controlling the signals transmitted over the protection band to pass through the second node device during the reception of the protection band control signal, and means for transferring the protection band control signal to the adjacent first node device or to the adjacent second node device during the reception of the protection band control signal. The first node device further includes means for receiving the protection band control signal transferred from the adjacent second node device. A ring path that starts at the first node device, passes through the plurality of second node devices, and ends at the first node device is created in the protection band, and is used to evaluate the communication quality of the protection band.

The present invention makes it possible to provide a ring network system that includes a means for setting a path for checking the communication quality of a protection band and is capable of creating, in the protection band, a ring path starting at the first node device, passing through the second node devices, and ending at the first node device. In the ring network system, a test signal generation unit of the first node device sends out test signals to the ring path created in the protection band, and a test signal measurement unit of the first node device performs measurements on the test signals. The communication quality of the protection band can thus be evaluated.

According to another aspect of the present invention, the ring network system is characterized in that the control signal is valid when a destination address and a source address in APS bytes have the same value.

According to this aspect, it is possible to provide a ring network system capable of creating a path for checking the communication quality of a protection band when a destination address and a source address in APS bytes received by a node device of the ring network system are the same.

The present invention makes it possible to check the communication quality of a protection band of a ring network system. Therefore, when a transmission band is switched from a working band to a protection band for line protection in the case of a line failure, the occurrence of another line failure after the line switching due to degradation in the communication quality of the protection band can be prevented.

### BRIEF DESCRIPTION OF THE DRAWINGS

FIG. 1 illustrates an exemplary ring network system.

FIG. 2 is a table for explaining K1 byte and K2 byte.

FIG. 3 is a diagram illustrating an exemplary configuration of a node device.

FIG. 4 is a diagram (1) illustrating exemplary operations of node devices.

FIG. 5 is a diagram (2) illustrating exemplary operations of node devices.

FIG. 6 is a flowchart illustrating an exemplary operation of a first node device.

FIG. 7 is a flowchart illustrating an exemplary operation of a second node device.

FIG. 8 is a diagram for illustrating a 2F-BLSR.

FIG. 9 is a diagram (1) illustrating the redundancy capabilities of a 2F-BLSR network.

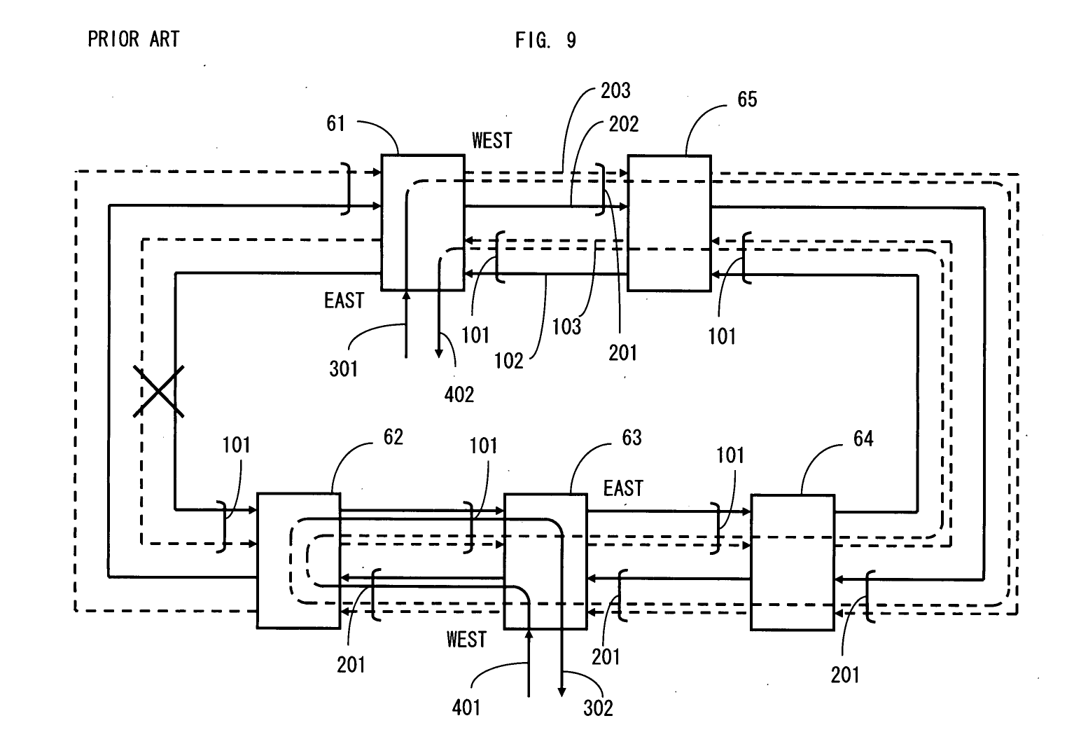

FIG. 10 is a diagram (2) illustrating the redundancy capabilities of a 2F-BLSR network.

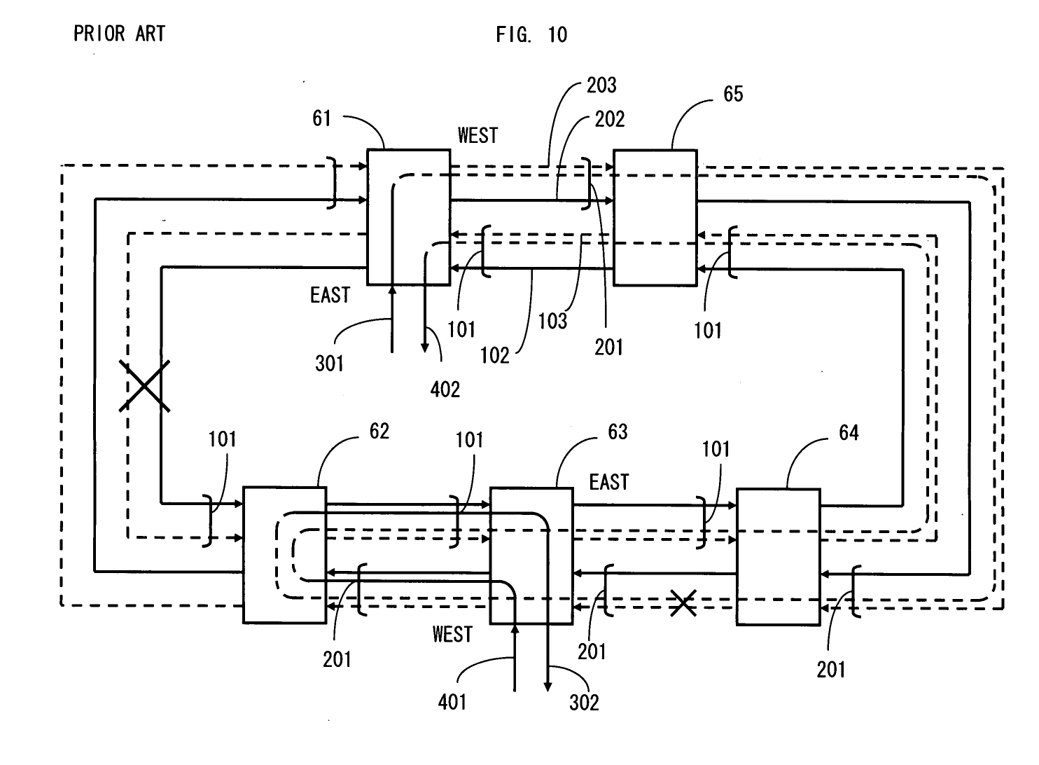

FIG. 11 is a diagram illustrating an exemplary line test.

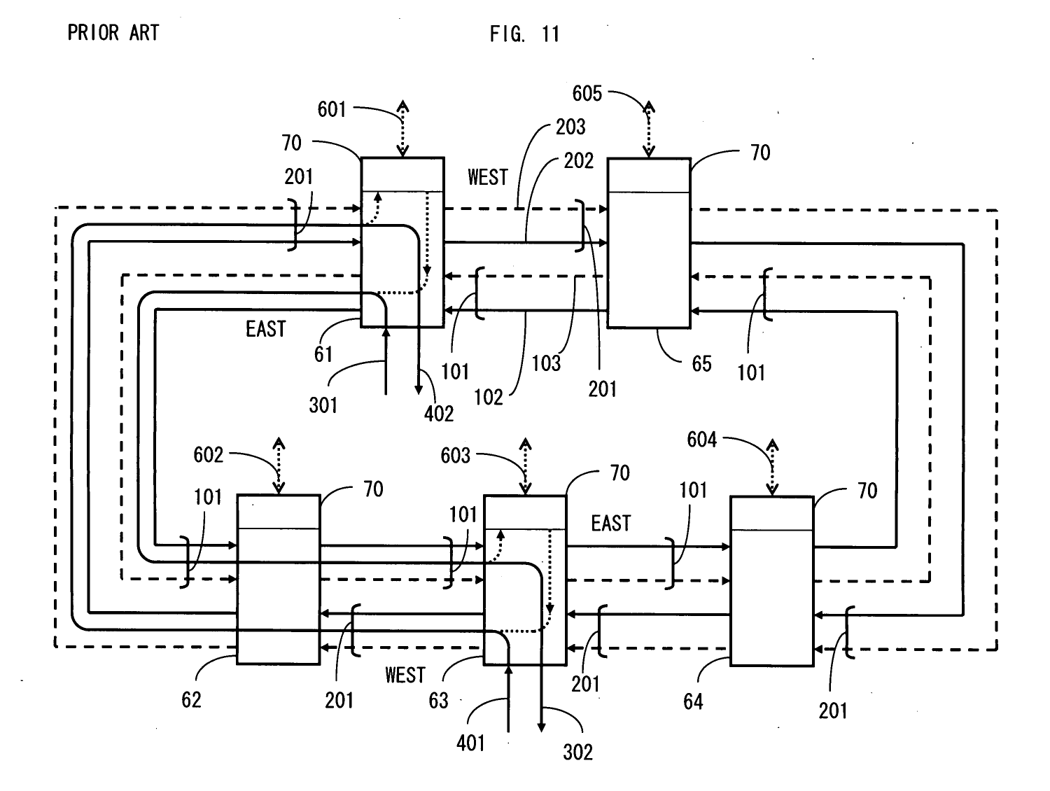

### DESCRIPTION OF THE PREFERRED EMBODIMENTS

The present invention will now be described in detail with reference to the drawings. Throughout the drawings, the same or like components are denoted by the same reference numerals.

### First Embodiment

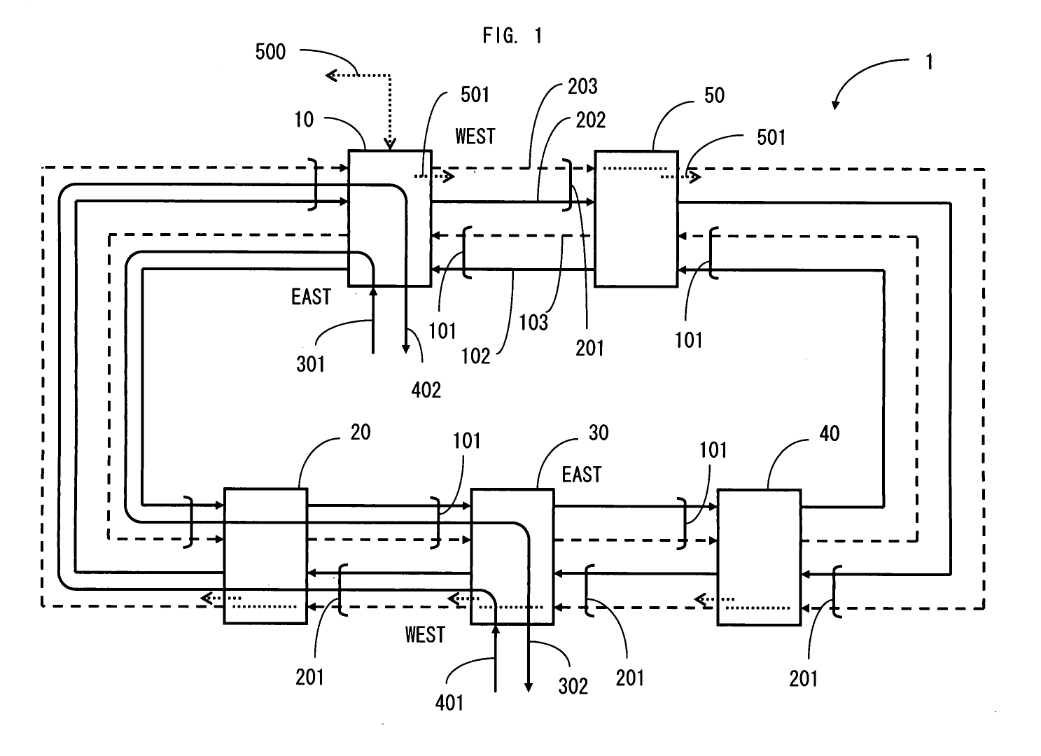

FIG. 1 illustrates an exemplary ring network system (ring network system 1) of the present invention. An EAST line 101, which is typically an optical fiber, is a transmission line for connecting node devices 10, 20, 30, 40, and 50 in EAST direction in a ring configuration. A WEST line 201, which is typically an optical fiber, is a transmission line for connecting the node devices 10, 20, 30, 40, and 50 in WEST direction in a ring configuration. A working band 102 and a protection band 103 are provided for signals transmitted over the EAST line 101. The working band 102 is provided for current use and the protection band 103 is provided for backup. Likewise, a working band 202 and a protection band 203 are provided for signals transmitted over the WEST line 201. The working band 202 is provided for current use and the protection band 203 is provided for backup. An ADD line 301 is added at the node device 10. A DROP line 302 is dropped at the node device 30. Likewise, an ADD line 401 is added at the node device 30. A DROP line 402 is dropped at the node device 10. A control/response signal 500 is a signal for interfacing with a network management system (NMS, not shown). A protection band control signal 501 is used to establish a path in a protection band for checking the communication quality of the protection band. The protection band control signal 501 is a control signal transmitted from each of the node devices 10, 20, 30, 40, and 50 to the adjacent node device in WEST direction. Although not illustrated in FIG. 1, there is also the protection band control signal 501 transmitted from each node device to the adjacent node device in EAST direction.

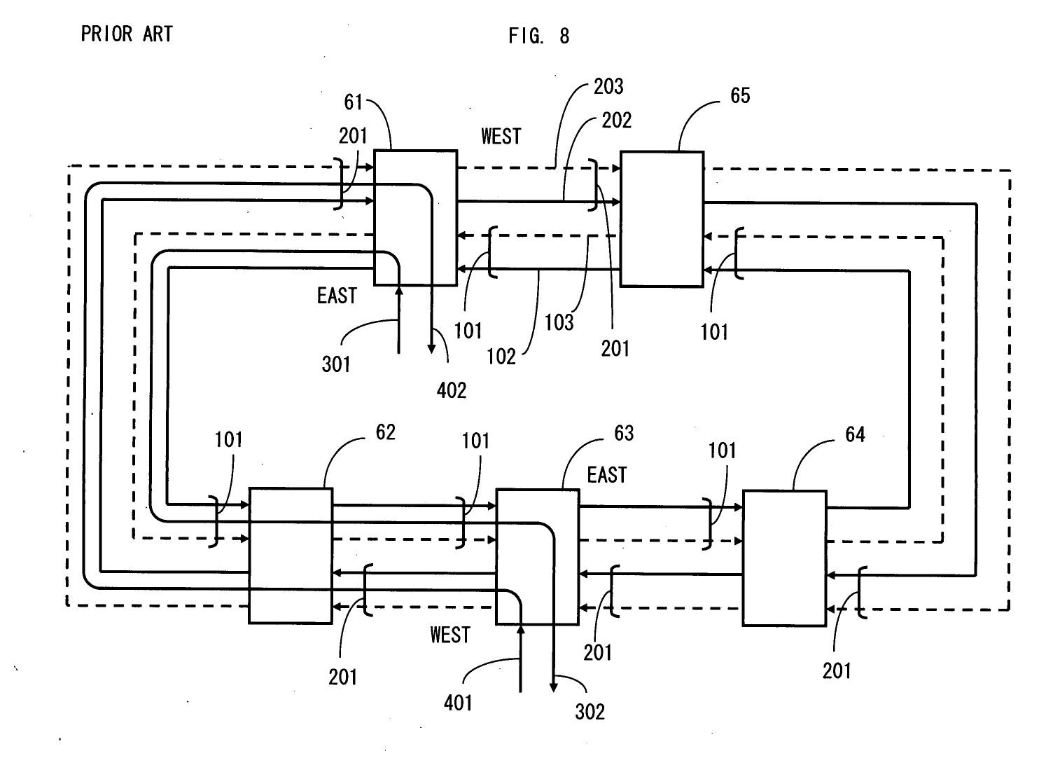

The ring network system 1 in FIG. 1 has a SONET ring configuration, which is the same as that described with reference to FIG. 8. Specifically, the ring network system 1 is a 2F-BLSR network in which a transmission band of a single optical fiber for each of different directions (EAST direction and WEST direction) is divided into a current band (working band) and a backup band (protection band). The node devices 10, 20, 30, 40, and 50 are SONET devices with ADM capabilities and are connected via the EAST line 101 and the WEST line 201. The transmission band of the EAST line 101 is divided into two sub-bands, i.e., the working band 102 for current use and the protection band 103 for backup. Likewise, the transmission band of the WEST line 201 is divided into two sub-bands, i.e., the working band 202 for current use and the protection band 203 for backup. In general, the widths of a working band and a protection band are the same. For example, when an optical carrier 48 (OC48) line with a capacity of 2.4 Gbps is used, 48 channels of a synchronous transport signal-1 (STS-1) for each of the EAST line 101 and the WEST line 201 are assigned equally to the working band and protection band, i.e., channels 1 to 24 are assigned to the working band and channels 25 to 48 are assigned to the protection band.

Both the EAST line 101 and the WEST line 201 have a SONET/SDH frame format (not shown). For example, the line overhead (LOH) of a SONET OC48 frame and the multiplex section overhead (MSOH) of an SDH synchronous transport module-16 (STM-16) frame has an APS field containing K1 and K2 bytes, which are used for the control of line switching operations and for the transfer of line statuses.

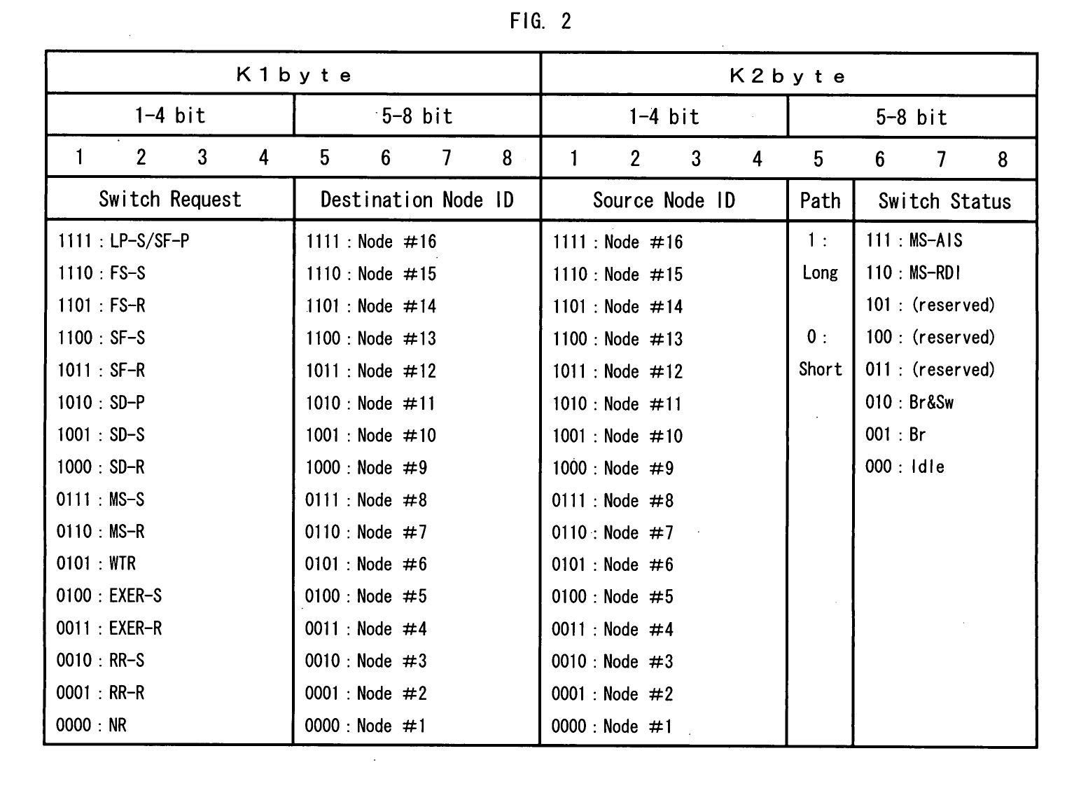

FIG. 2 is a table for explaining K1 and K2 bytes. The first to fourth bits of K1 byte represent switch request signals (or switch requests) for the control of line switching operations. For example, FS-S (FS: forced switch) corresponding to switch request 1110 and FS-R corresponding to switch request 1101 represent control signals for directing transmitted signals from a working line toward a protection line in response to certain commands, when the protection line is in a normal state. Specifically, FS-S represents a control signal acting as a forced span switch and FS-R represents a control signal acting as a forced ring switch. Additionally, SD-S (SD: signal degrade) corresponding to switch request 1001 and SD-R corresponding to switch request 1000 represent control signals for directing transmitted signals from the working line toward the protection line, when the protection line is in a normal state, upon detection of signal degradation on the working line. Specifically, SD-S represents a control signal indicating that there is span signal degradation on the working line, while SD-R represents a control signal indicating that there is ring signal degradation on the working line. SD-P corresponding to switch request 1010 represents a signal used in a 4F-BLSR network and indicating that there is signal degradation on a protection line.

The fifth to eighth bits of K1 byte represent destination node IDs. The first to fourth bits of K2 byte represent source node IDs.

The fifth bit of K2 byte represents line types. The sixth to eighth bits of K2 byte represent signals for transferring line statuses and line switching statuses.

A source node device (represented by a source node ID) from which the node device is to be switched transmits a switch request signal to a destination node device (represented by a destination node ID) to which the node device is to be switched.

The following describes an example in which the node device 10 in FIG. 1 checks the line conditions of a protection band.

Upon receipt of the control signal 500 from the NMS, the node device 10 sends out to the adjacent node device 50 the protection band control signal 501 for establishing a path for checking the communication quality of a protection band. Upon receipt of the protection band control signal 501, the node device 50 puts the protection band 203 into a “pass-through” state in which signals transmitted from the node device 10 over the protection band 203 (e.g., channels 25 to 48) are directly transmitted to the node device 40. Then, the node device 50 transfers the protection band control signal 501 to the adjacent node device 40. Likewise, upon receipt of the protection band control signal 501, the node device 40 puts the protection band 203 into a “pass-through” state and transfers the protection band control signal 501 to the adjacent node device 30. Upon receipt of the protection band control signal 501, the node device 30 puts the protection band 203 into a “pass-through” state and transfers the protection band control signal 501 to the adjacent node device 20. Upon receipt of the protection band control signal 501, the node device 20 puts the protection band 203 into a “pass-through” state and transfers the protection band control signal 501 to the adjacent node device 10. Then, upon receipt of the protection band control signal 501, the node device 10 sends out the response signal 500 to the NMS.

With the above-described operation of the node devices 10, 20, 30, 40, and 50 in the ring network, a path starting and ending at the node device 10 is created in the protection band 203 of the ring network system 1.

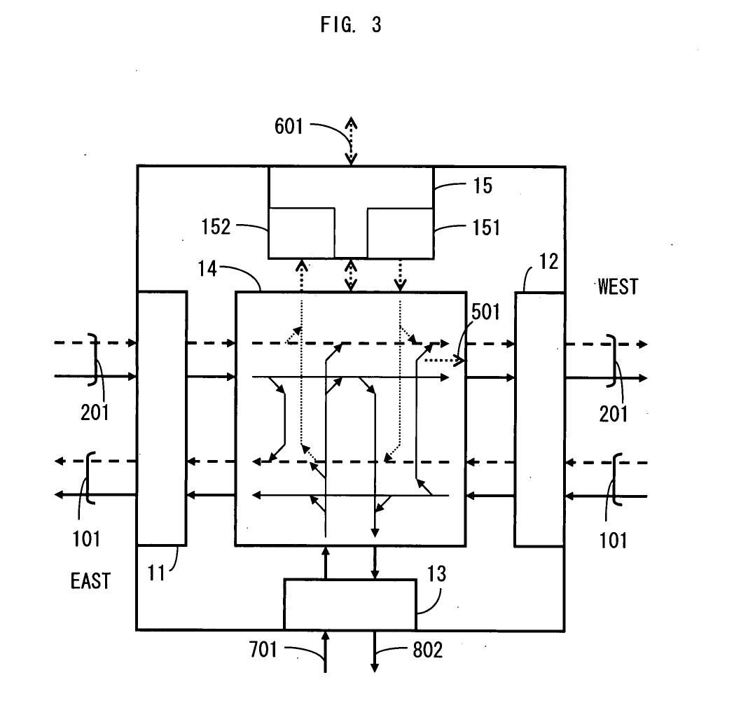

FIG. 3 is a diagram illustrating an exemplary configuration of a node device. The node device includes line interfaces 11 and 12, an intra-office line interface 13, an ADM unit 14, and a test controller 15 including a test signal generation unit 151 and a test signal measurement unit 152. A control/response signal 601 is a signal for interfacing the node device with an NMS. An ADD line 701 and a DROP line 802 are lines for interfacing the node device with intra-office devices.

Signals transmitted over the EAST line 101 are received at the line interface 12. In the ADM unit 14, signals on a predetermined “drop” channel are transmitted through the intra-office line interface 13 to the DROP line 802. Signals from the ADD line 701 are transmitted through the intra-office line interface 13, added to a predetermined “add” channel, and transmitted through the line interface 11 to the EAST line 101.

Likewise, signals transmitted over the WEST line 201 are received at the line interface 11. In the ADM unit 14, signals on a predetermined “drop” channel are transmitted through the intra-office line interface 13 to the DROP line 802. Signals from the ADD line 701 are transmitted through the intra-office line interface 13, added to a predetermined “add” channel, and transmitted through the line interface 12 to the WEST line 201.

The control signal 601 from the NMS is detected at the test controller 15, which controls add-drop operations in the ADM unit 14, controls the protection band control signal 501 for establishing a path for checking the communication quality of a protection band, and performs control for setting signals for K1 and K2 bytes.

The ADM unit 14 is capable of performing add/drop operations on channel signals on the EAST line 101 and WEST line 201, allowing the channel signals to pass through, returning and diverting the channel signals from the working band to appropriate channels in the protection band for protecting line signals, directing test signals generated by the test signal generation unit 151 to specific channels in the protection band, and directing the test signals in the protection band to the test signal measurement unit 152. The ADM unit 14 is also capable of directing signals on the ADD line 701 to the protection band and directing signals in the protection band to the DROP line 802.

According to the present embodiment described above, it is possible to create, in a protection band of a ring network, a ring path for transmitting test signals to the protection band, and thus possible to test the state of the protection band.

### Second Embodiment

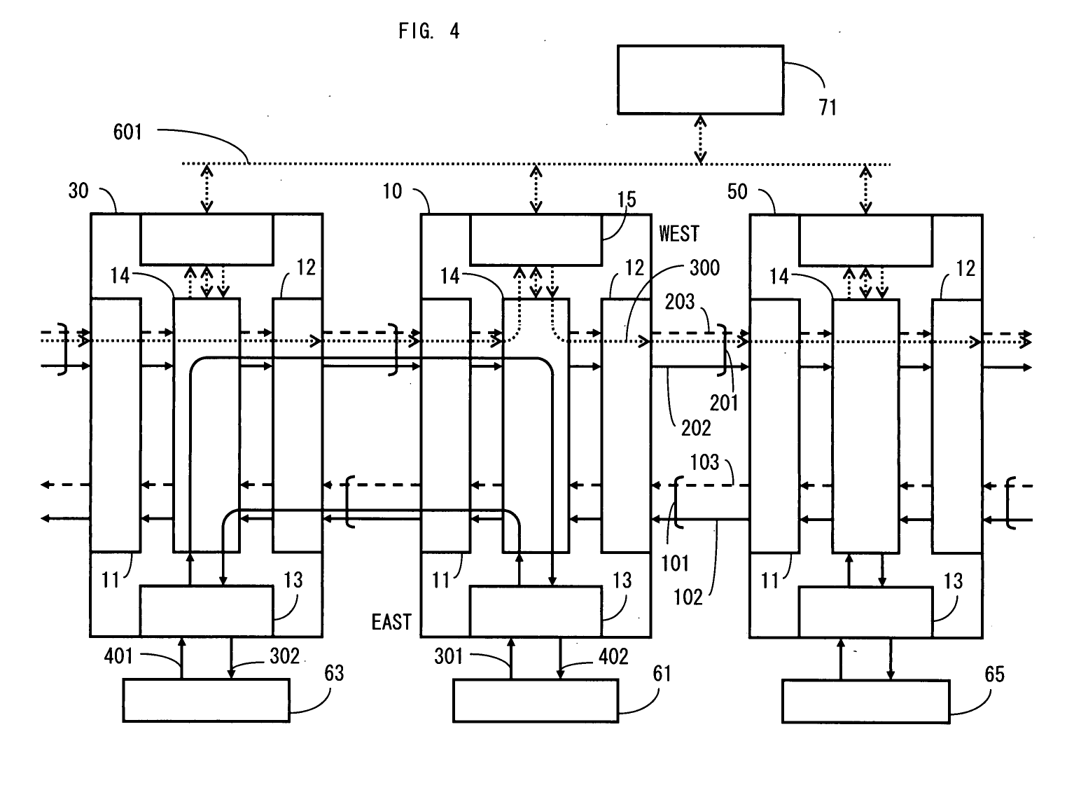

FIG. 4 is a diagram (1) illustrating exemplary operation of node devices. Of all the node devices 10 to 50 in the ring network system 1 illustrated in FIG. 1, the node devices 20 and 40 are omitted in FIG. 4. Intra-office devices 61, 63, and 65 are connected to the node devices 10, 30, and 50, respectively, within the corresponding offices (stations). An NMS 71 controls the node devices 10, 30, and 50 and the like. Each of the node devices 10, 30, and 50 includes line interfaces 11 and 12, an intra-office line interface 13, an ADM unit 14, and a test controller 15. A control/response signal 601 interfaces between the NMS 71 and the node device 10. Although FIG. 4 illustrates the connection between the NMS 71 and the node device 10 only, the NMS 71 is connected to either of the node devices 30 and 50 in the same manner as to the node device 10.

As in the case of the ring network system illustrated in FIG. 1 or FIG. 8, paths for the intra-office device 61 and the node device 63 are created between the node device 10 and the node device 30. In the node device 10, signals transmitted from the intra-office device 61 through the ADD line 301 are received at the intra-office line interface 13 and added to the working band 102 of the EAST line 101 in the ADM unit 14, on the basis of ADM information defined according to information from the NMS 71. Then, in the node device 30, the signals are dropped from the working band 102 in the ADM unit 14, on the basis of ADM information defined according to information from the NMS 71, and output from the intra-office line interface 13 through the DROP line 302 to the node device 63. Likewise, in the node device 30, signals transmitted from the intra-office device 63 through the ADD line 401 are received at the intra-office line interface 13 and added to the working band 202 of the WEST line 201 in the ADM unit 14, on the basis of ADM information defined according to information from the NMS 71. Then, in the node device 10, the signals are dropped from the working band 202 in the ADM unit 14, on the basis of ADM information defined according to information from the NMS 71, and output from the intra-office line interface 13 through the DROP line 402 to the node device 61.

The node device 10 receives, from the NMS 71, the control signal 601 for establishing a path for checking the communication quality of the protection band 203. On the basis of the received control signal 601, the node device 10 creates an “add” path in the ADM unit 14 such that test signals generated by the test signal generation unit 151 of the test controller 15 are transmitted over the protection band 203. Then, the node device 10 assigns an ID value to the adjacent node device 50 such that the source node ID in the first to fourth bits of K2 byte in the WEST line 201 is the same as the destination node ID in the fifth to eighth bits of K1 byte (e.g., the destination node ID=0000 and the source node ID=0000).

The node device 50 terminates the WEST line 201 at the line interface 11 and detects K1 and K2 bytes. When the destination node ID and the source node ID are the same, the ADM unit 14 creates a through path that allows signals transmitted over the protection band 203 to pass through. Then, the node device 50 assigns an ID value to the adjacent node device 30 such that the source node ID in the first to fourth bits of K2 byte in the WEST line 201 is the same as the destination node ID in the fifth to eighth bits of K1 byte. Examples of possible combinations of node IDs are: the destination node ID=0000 and source node ID=0000 that are transmitted from the node device 10; destination node ID=0100 and source node ID=0100; and destination node ID=0010 and source node ID=0010.

The node device 30 operates in the same manner as the node device 50. The node device 30 terminates the WEST line 201 at the line interface 11 and detects K1 and K2 bytes. When the destination node ID and the source node ID are the same, the ADM unit 14 creates a through path that allows signals transmitted over the protection band 203 to pass through. Then, the node device 50 assigns an ID value to the adjacent node device 10 such that the source node ID in the first to fourth bits of K2 byte in the WEST line 201 is the same as the destination node ID in the fifth to eighth bits of K1 byte. For example, a destination node ID and a source node ID that are to be used may be those transmitted from the node device 30, or those newly created.

The node device 50 terminates the WEST line 201 at the line interface 11 and detects K1 and K2 bytes. If the destination node ID and the source node ID are the same, the ADM unit 14 creates a “drop” path so that the evaluation of communication quality can be performed, in the test signal measurement unit 152 of the test controller 15, on the signals transmitted over the protection band 203.

The above-described operations of the node devices 10, 30, and 50 in the ring network create a path 300 that starts and ends at the node device 10 in the protection band 203 of the ring network system, and allow test signals generated by the test signal generation unit 151 to be transmitted over the path 300 and measured by the test signal measurement unit 152. The communication quality of the protection band 203 can thus be evaluated.

Although only the protection band 203 of the WEST line 201 has been described above, the protection band 103 of the EAST line 101 can also be evaluated in the same manner as that described above.

If the above-described condition “destination node ID=source node ID” is cancelled, the through path in the ADM unit 14 in each of the node devices 30 and 50 and the “drop” path in the ADM unit 14 of the node device 10 are also cancelled.

According to the present embodiment described above, it is possible to create, in node devices of a ring network, a path for transmitting test signals over a protection band of the ring network.

### Third Embodiment

In the present embodiment based on the configuration illustrated in FIG. 4, a destination node ID and a source node ID that satisfy “destination node ID=source node ID” in K1 and K2 bytes are transmitted, as a protection band control signal, from a node device to an adjacent node device so that a path for checking the communication quality of a protection band can be established. It is also possible to use one of 101, 100, and 011 in the sixth to eighth bits of K2 byte in FIG. 2 as the protection band control signal.

### Fourth Embodiment

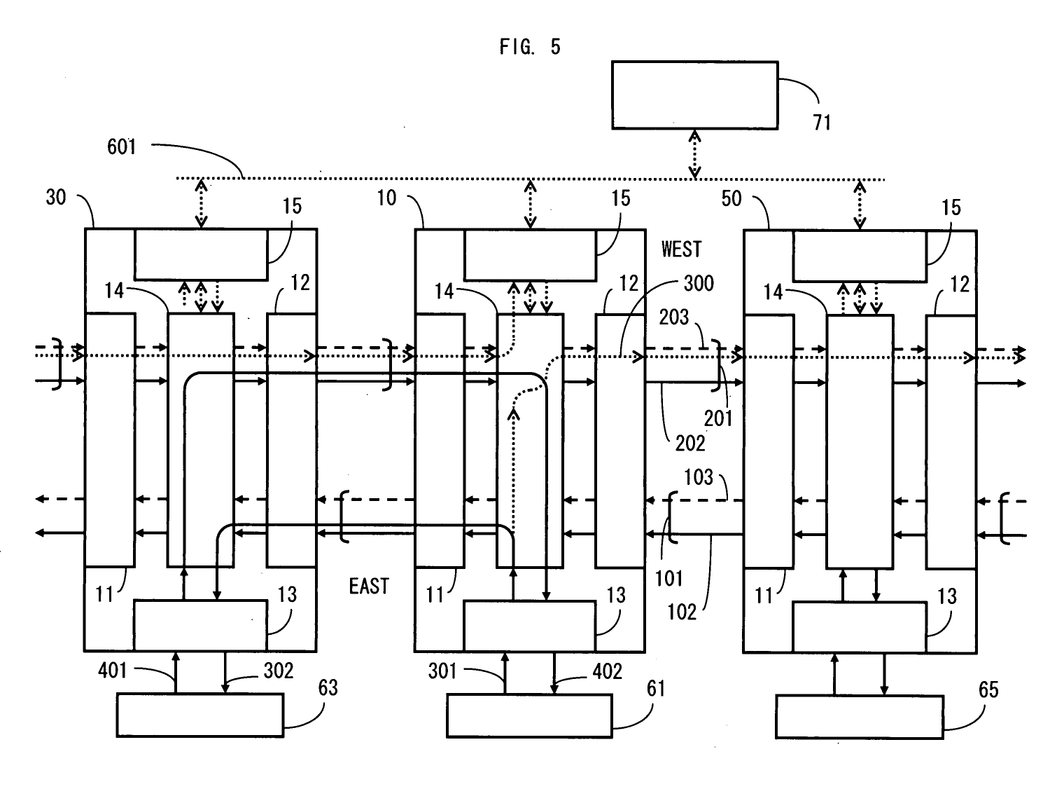

FIG. 5 is a diagram (2) illustrating exemplary operations of node devices. A ring network system illustrated in FIG. 5 has the same system configuration as that illustrated in FIG. 4. In the present embodiment, signals coming from the intra-office device 61 through the ADD line 301 and transmitted from the node device 10 to the node device 30 are used as test signals. The communication quality of the protection band 203 of the WEST line 201 can thus be checked by the node device 10, as in the case of the second embodiment.

The node device 10 receives, from the NMS 71, the control signal 601 for establishing a path for checking the communication quality of the protection band 203. On the basis of the received control signal 601, the ADM unit 14 of the node device 10 adds signals from the ADD line 301 to the working band 102 of the EAST line 101 and, at the same time, to the protection band 203 of the WEST line 201. This allows a path 300 that starts and ends at the node device 10 to be created in the protection band 203 of the ring network system, as in the case of the second embodiment.

Since the path 300 that starts and ends at the node device 10 is created in the protection band 203 of the ring network system, and signals on the ADD line 301 are transmitted over the path 300 and measured by the test signal measurement unit 152, the communication quality of the protection band 203 can be evaluated.

### Fifth Embodiment

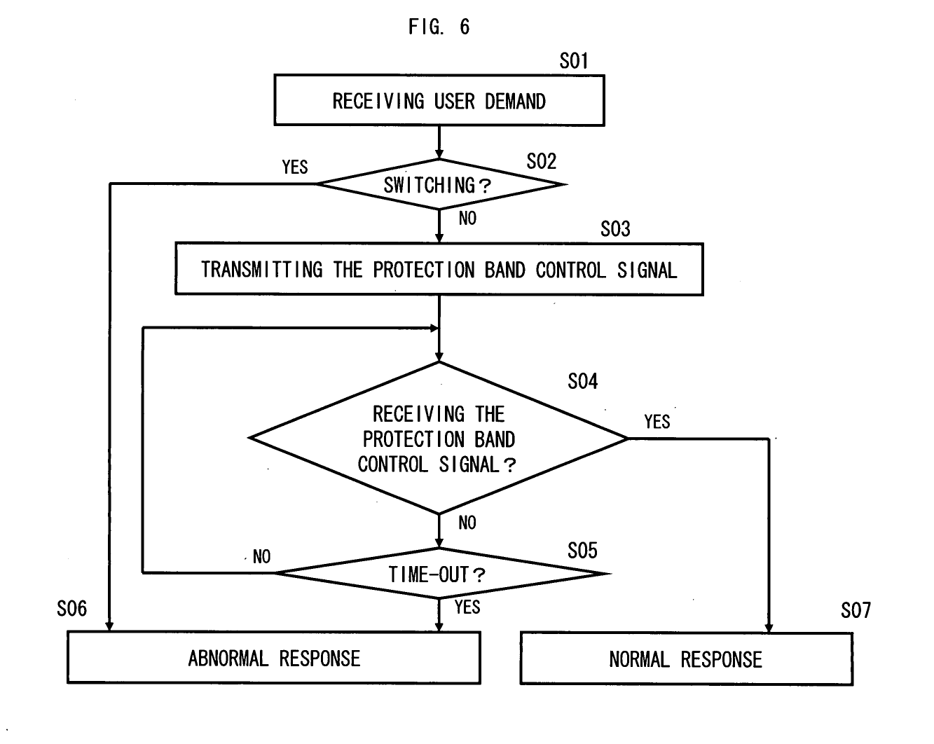

FIG. 6 is a flowchart illustrating an exemplary operation of a first node device, which is equivalent to the node device 10 described with reference to FIGS. 1, 3, and 4. The first node device serves as the start and end points for creating a round path to be used in testing a protection band.

Step S01: From the NMS, the first node device receives a user request, in the form of a line test control signal, for performing a line test on the protection band.

Step S02: The first node device determines whether the protection band is not in use in the ring network.

Step S03: The first node device sends out, to an adjacent second node device, a protection band control signal for establishing a path for checking the communication quality of the protection band. In the protection band control signal, a destination node ID in K1 byte and a source node ID in K2 byte may be the same, or the sixth to eighth bits of K2 byte may be defined as one of 101, 100, and 011.

Step S04: The first node device determines whether a protection band control signal has been received from the direction opposite the direction in which the protection band control signal was sent out in step S03.

Step S05: If it is determined in step S04 that the protection band control signal has not been received, the first node device determines in step S05 whether the amount of time that has elapsed from the time when the protection band control signal was sent out in step S03 exceeds a timeout period predefined according to the characteristics of the ring network system.

Step S06: If it is determined in step S02 that the protection band is in use, or if it is determined in step S05 that a timeout occurs, the first node device returns an “abnormal” response to the NMS in response to the user request received in step S01.

Step S07: If the first node device has received in step S04 the protection band control signal before a timeout occurs, in other words, if the protection band control signal sent out in step S01 has been transmitted around the entire ring network and a round path for testing the protection band has been created, the first node device returns a “normal” response to the NMS.

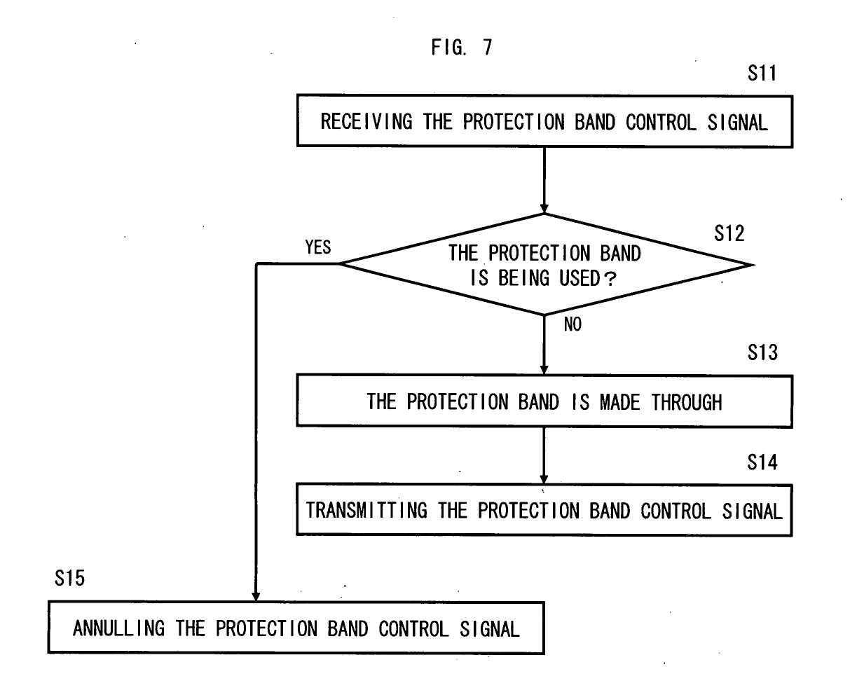

FIG. 7 is a flowchart illustrating an exemplary operation of a second node device, which is equivalent to either of the node devices 20, 30, 40, and 50 described with reference to FIGS. 1, 3, and 4. In the second node device, a protection band is placed in a pass-through state so that a round path for testing the protection band can be created.

Step S11: From an adjacent first node device or another second node device, the second node device receives a protection band control signal for establishing a path for checking the communication quality of the protection band. In the protection band control signal, a destination node ID in K1 byte and a source node ID in K2 byte may be the same, or the sixth to eighth bits of K2 byte may be defined as one of 101, 100, and 011.

Step S12: The second node device determines whether the protection band is not in use in the ring network.

Step S13: If it is determined in step S12 that the protection band is not in use, the second node device keeps the protection band in a through state.

Step S14: The second node device sends out a protection band control signal to the adjacent first or second node devices in the same direction as the flow of the protection band control signal received in step S11. The protection band control signal to be sent out is a control signal defined in the same manner as in step S11.

In the protection band of a SONET ring composed of the first node device and the plurality of second node devices, a round path starting and ending at the first node device and passing through the second node devices can thus be created and allow the communication quality of the protection band to be tested.

What is claimed is:

1. A ring network system comprising:
a first node device;
a plurality of second node devices; and
a transmission line for connecting the first node device and the plurality of second node devices in a ring configuration,
wherein each of the first node device and the second node devices combines a working band used as a normal band for transmitting signals and a protection band used as an alternative band for diverting signals to form a redundant transmission band pair;
the first node device comprises means for sending out a protection band control signal for controlling one of the second node devices so as to allow signals transmitted over the protection band to pass through the second node device;
each of the second node devices comprises means for receiving the protection band control signal sent out from one of the first node device and another second node device, means for controlling the signals transmitted over the protection band to pass through the second node device while receiving the protection band control signal, and means for transferring the protection band control signal to one of the first node device and the adjacent second node device while receiving the protection band control signal;
the first node device further comprises means for receiving the protection band control signal transferred from the adjacent second node device; and
a ring path that starts at the first node device, passes through the plurality of second node devices, and ends at the first node device is set up in the protection band, and is used to evaluate a communication quality of the protection band.

2. The ring network system according to claim 1,
wherein the protection band control signal is valid, while a destination address in K1 byte and a source address in K2 byte have the same value in the section overhead of a frame used by a transmission device.

3. The ring network system according to claim 1,
wherein an unused portion of K2 byte is used as the protection band control signal.

4. The ring network system according to claim 1,
wherein the communication quality of the protection band is evaluated by transmitting test signals over the protection band from the first node device through the plurality of second node devices to the first node device.

5. A node device for connecting to a transmission line to form a ring network with other node devices, the node device comprising:
a ring line interface circuit for receiving and transmitting a multiframe signal having a working band used as a normal band for transmitting signals and a protection band used as an alternative band for diverting signals;
a setting circuit for dropping or adding the multiframe signal received by the ring line interface circuit on the basis of a received control signal; and
a test controller for controlling the dropping or adding the multiframe signal,
wherein the ring line interface circuit detects and generates a protection band control signal for testing a path in the protection band;
the setting circuit sets the path in the protection band into a pass-through state on the basis of the protection band control signal; and
the test controller controls the execution of a path test for the protection band, generates test signals for the path test, and performs measurements for the path test.

6. The node device according to claim 5,
wherein the protection band control signal is valid while a destination address in K1 byte and a source address in K2 byte have the same value in the section overhead of a SONET/SDH frame.

7. The node device according to claim 5,
wherein an unused portion of K2 byte is used in the protection band control signal.

8. The node device according to claim 5,
wherein the communication quality of the protection band is evaluated by transmitting test signals over the protection band from the first node device through the plurality of second node devices to the first node device.

9. A protection band testing method for a ring network system in which a first node device and a plurality of second node devices are connected in a ring configuration, and a working band and a protection band combine to form a redundant transmission band pair, the protection band testing method comprising the steps of:
sending out, from the first node device, a control signal for controlling one of the second node devices so as to allow signals transmitted over the protection band to pass through the second node device;
at one of the second node devices,
receiving the control signal sent out from one of the first node device and another second node device;
controlling the signals transmitted over the protection band to pass through the second node device while receiving the control signal;
transferring the control signal to one of the first node device and the adjacent second node device while receiving the control signal; and
receiving, at the first node device, the control signal transferred from the adjacent second node device,
wherein a ring path that starts at the first node device, passes through the plurality of second node devices, and ends at the first node device is created in the protection band, and is used to evaluate the communication quality of the protection band.

10. The protection band testing method according to claim 9,
wherein the control signal is valid, while a destination address in K1 byte and a source address in K2 byte have the same value in the section overhead of a frame used by a transmission device.

11. The protection band testing method according to claim 9,
wherein an unused portion of K2 byte is used in the control signal.

12. The protection band testing method according to claim 9,
wherein the communication quality of the protection band is evaluated by transmitting test signals over the protection band from the first node device through the plurality of second node devices to the first node device.
